(19) United States
(12) Patent Application Publication
(10) Pub. No.: US 2009/0116892 A1
(43) Pub. Date: May 7, 2009

(54) DUAL INPUT APPARATUS AND METHOD FOR SUPPORTING KEYBOARD FUNCTIONS

(75) Inventor: Jaewoo Ahn, Gyeonggi-do (KR)

Correspondence Address: CANTOR COLBURN, LLP, 20 Church Street, 22nd Floor, Hartford, CT, 06103, US

(73) Assignee: MOBIENCE, INC., Seongnam-si (KR)

(21) Appl. No.: 12/295,983

(22) PCT Filed: Apr. 6, 2007
(86) PCT No.: PCT/KR07/01700

§ 371 Date: Oct. 3, 2008

(30) Foreign Application Priority Data
Apr. 6, 2006 (KR) 10-2006-0031527
May 22, 2006 (KR) 10-2006-0045901
Jun. 14, 2006 (KR) 10-2006-0053280
Jan. 2, 2007 (KR) 10-2007-0000244

(51) Int. Cl. B41J 5/00

(52) U.S. Cl. 400/489

(57) ABSTRACT

Disclosed is a method and apparatus for conveniently inputting characters with both hands and inputting characters as many as possible with a limited number of keys.

### TECHNICAL FIELD

The present invention relates to a method and apparatus for inputting characters.

### BACKGROUND ART

Advanced semiconductor technologies have resulted in more compact and high-performing portable terminals, such as mobile phones and personal digital assistants (PDAs). The portable terminal has a character input means to allow users to input characters. The portable terminal typically has a single input means, leading to a sub-stantially reduced input speed.

On the other hand, the input means is an obstacle to the compact portable terminals which require input keys as many as computer keyboards.

### DISCLOSURE OF INVENTION

### Technical Problem

In order to avoid the obstacle, the conventional portable terminals have a computer keyboard which is reduced in size as much as possible. However, there is a limit in reducing the size of the keyboard.

### Technical Solution

The present invention provides a method and apparatus for conveniently inputting characters with both hands.

The present invention further provides a method and apparatus for inputting characters provided on a computer keyboard with a limited number of keys.

Additional features of the invention will be set forth in the description which follows, and in part will be apparent from the description, or may be learned by practice of the invention.

### Advantageous Effects

According to the present invention, it is possible to conveniently input characters using both hands. In addition, it is possible to input all characters of a computer keyboard with a limited number of keys. Furthermore, it is possible to provide keys which are assigned applications or user-defined functions.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a dual input apparatus according to an exemplary embodiment of the invention.

FIG. 2 illustrates a dual input apparatus according to an exemplary embodiment of the invention.

FIG. 3 illustrates a dual input apparatus according to another exemplary embodiment of the invention.

FIG. 4 illustrates a dual input apparatus according to another exemplary embodiment of the invention.

FIG. 5 illustrates a dual input apparatus according to another exemplary embodiment of the invention.

FIG. 6 illustrates a dual input remote control.

FIG. 7 illustrates another dual input remote control.

FIG. 8 illustrates first and second key selection units each having a 5-by-3 array of keys according to an exemplary embodiment of the invention.

FIGS. 9 to 12 illustrate character mode changes in a text mode.

FIG. 13 illustrates symbol keys assigned in a text mode.

FIG. 14 illustrates keys assigned when a text mode is changed to a keyboard mode.

FIG. 15 illustrates a keyboard related to FIG. 14.

FIG. 16 illustrates assigned function keys of a keyboard.

FIG. 17 illustrates a keyboard related to FIG. 16.

FIG. 18 illustrates assigned movement keys of a keyboard.

FIG. 19 illustrates a keyboard related to FIG. 18.

FIGS. 20 to 25 illustrate assignment of character keys of a keyboard.

FIGS. 26 and 27 illustrate assignment of numeral and symbol keys of a keyboard.

FIG. 28 illustrates a keyboard related to FIG. 26.

FIGS. 29 and 30 illustrate assignment of other keys of a keyboard.

FIG. 31 illustrates a keyboard related to a first key selection unit shown in FIG. 29.

FIG. 32 illustrates a keyboard related to a second key selection unit shown in FIG. 29.

FIG. 33 illustrates assignment of character, numeral, and symbol keys of a keyboard.

FIGS. 34 to 38 illustrate assigned system keys.

FIG. 39 illustrates assigned user-defined application keys.

FIG. 40 illustrates assigned user-defined function keys.

FIG. 41 illustrates assigned user-defined application and function keys.

FIG. 42 illustrates a key array for a joystick according to an exemplary embodiment of the invention.

FIG. 43 illustrates an input method in a joystick.

### BEST MODE FOR CARRYING OUT THE INVENTION

The present invention discloses a dual input apparatus including: a first key selection unit having a limited number of keys for a left hand; a second key selection unit having the same number of keys for a right hand as the first key selection unit; and a key processing unit to analyze and process a key selected by the first or second key selection unit.

The key processing unit may assign characters in a text mode to at least some of the limited number of keys of the first and second key selection units and output a selected key; and assign keys of a computer keyboard in a keyboard mode to at least some of the limited number of keys of the first and second key selection units and process an action corresponding to the selected key.

The key processing unit may reassign other keys of the computer keyboard to at least some of the limited number of keys when the key selected by the first of second key selection unit is input in the keyboard mode.

The present invention also discloses a method for inputting characters provided on a computer keyboard, including: assigning characters in a text mode to at least some of a limited number of keys in each of first and second key selection units for left and right hands, respectively, and outputting a character of a selected key, the first and second key selection units having the same number of keys; and assigning keys of the computer keyboard in a keyboard mode to at least some of the limited number of keys in each of the first and second key selection units, and processing an action corresponding to the selected key.

The step of assigning keys of the computer keyboard may include reassigning other keys of the computer keyboard to at least some of the limited number of keys in each of the first and second key selection units when a key selected by the first or second key selection unit is input in the keyboard mode.

It is to be understood that both the foregoing general description and the following detailed description are exemplary and explanatory and are intended to provide further explanation of the invention as claimed.

### Mode for the Invention

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

FIG. 1 is a block diagram of a dual input apparatus according to an exemplary embodiment of the invention.

The dual input apparatus includes a first key selection unit 100, a second key selection unit 200, and a key processing unit 300. The first key selection unit 100 consists of a limited number of keys which are input with a left hand. The second key selection unit 200 consists of the same number of keys as the first key selection unit 100, which are input with a right hand. The first and second key selection units 100 and 200 preferably consist of 18 keys, each having an array of 5 rows and 3 columns (hereinafter referred to as 5-by-3).

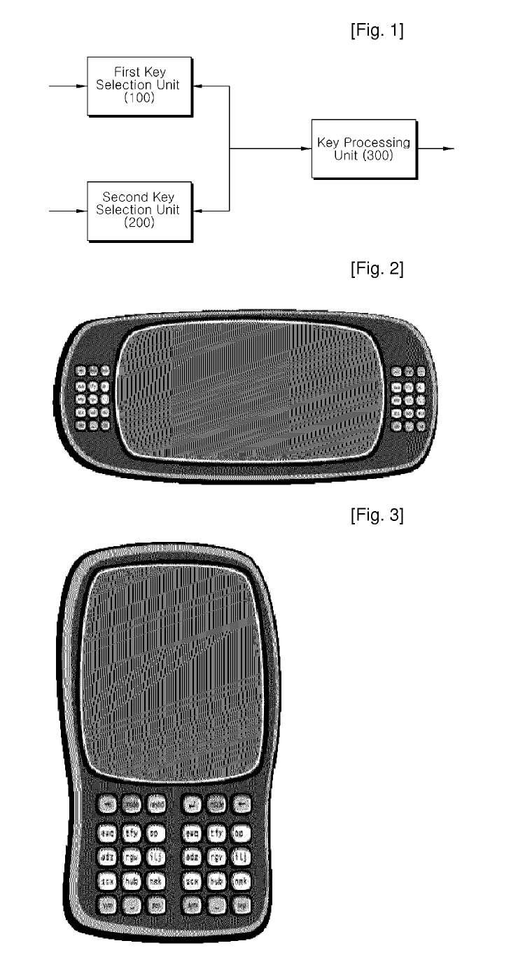

FIGS. 2 to 5 illustrate dual input apparatuses according to an exemplary embodiment of the invention.

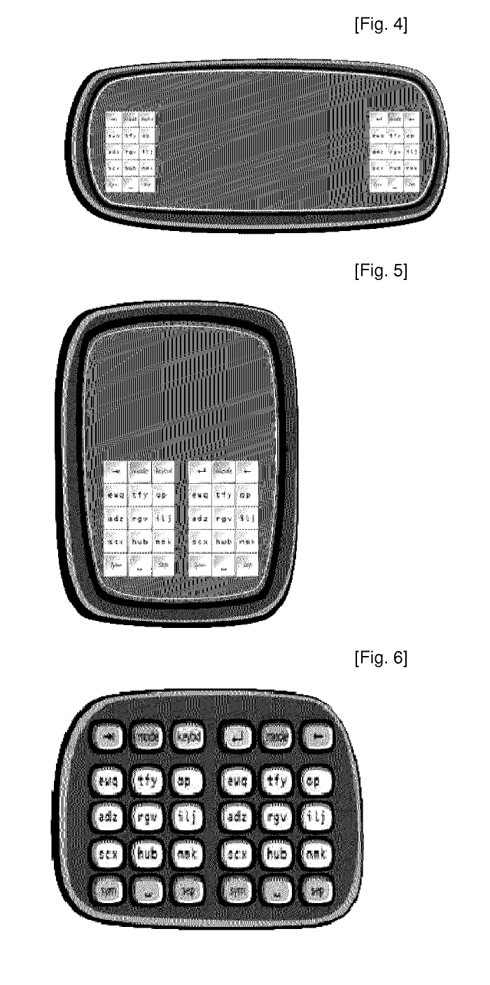

FIGS. 2 and 3 illustrate dual input apparatuses each having a physical key selection unit. FIGS. 4 and 5 illustrate dual input apparatuses each having a key selection unit in software. The dual input apparatuses have the first key selection unit 100 and the second key selection unit 200.

Referring to FIGS. 2 and 3, the first and second key selection units 100 and 200 are displayed on a display since keys of the key selection units 100 and 200 may be differently defined. For instance, when the first and second key selection units 100 and 200 are switched from an English alphabet mode to a Hangeul mode, i.e., Korean alphabet mode, the key selection units 100 and 200 need to be assigned consonants and vowels of Hangeul. However, since the physical key selection units 100 and 200 cannot be changed to have the Hangeul mode, the key selection units 100 and 200 are displayed on a display so that the key selection units 100 and 200 can be changed to have the Hangeul mode on the display.

Referring to FIGS. 4 and 5, the first and second key selection units 100 and 200 are displayed on a display. In this case, since the key selection units 100 and 200 do not exist physically but in software, it is possible to make more compact key selection units 100 and 200. The user can select keys through the key selection units 100 and 200 displayed on the display. In this case, input means, such as touch screen, remote control, mouse, and joystick, can be used to input keys.

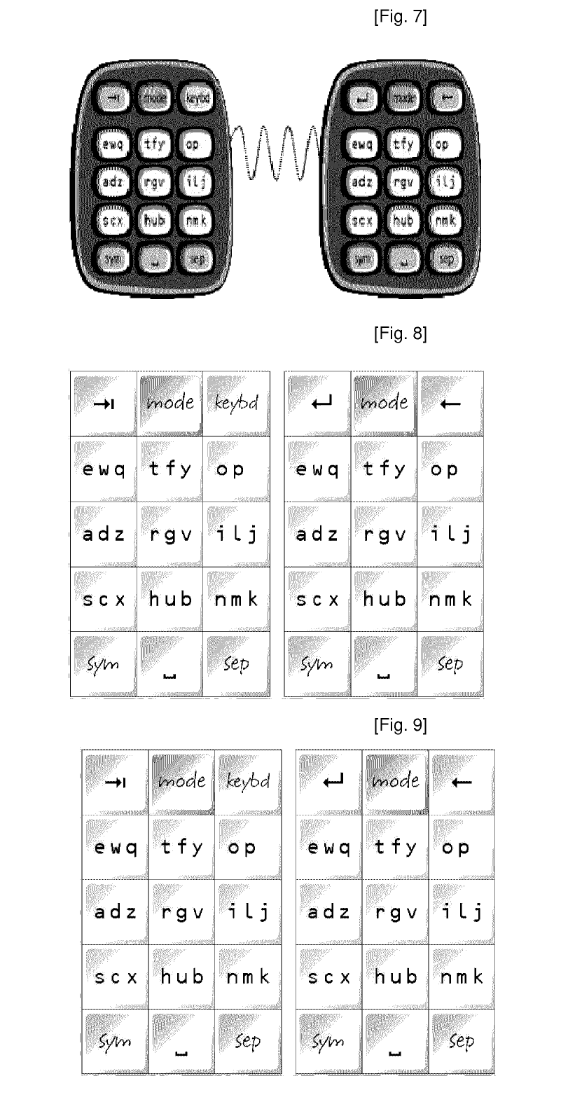

FIGS. 6 and 7 illustrate dual input remote controls.

FIG. 6 illustrates a remote control which includes key selection parts each having the same 5-by-3 array as that of the first and second key selection units 100 and 200. In this case, the key selection parts are integrated in the remote control. FIG. 7 illustrates a separated remote control which includes key selection parts each having the same 5-by-3 array as that of the first and second key selection units 100 and 200. In this case, the key selection parts are separately provided in the separated remote control.

The key processing unit 300 analyzes and processes a key selected by the first or second key selection unit 100 or 200. For instance, the key processing unit 300 displays on a display a character corresponding to a key selected by the first or second key selection unit 100 or 200 in a text mode, or displays on the display the Explorer corresponding to a key selected by the first or second key selection unit 100 or 200 in a keyboard mode. The key processing unit 300 may redefine the keys according to the selected key.

FIG. 8 illustrates first and second key selection units 100 and 200 each having a 5-by-3 array of keys according to an exemplary embodiment of the invention.

FIG. 8 illustrates a key array in a text mode, in which English alphabets are assigned to at least some of the first and second key selection units 100 and 200. The text mode typically supports characters inputted in portable terminals.

As shown in FIG. 8, the same 3-by-3 array of English alphabets is initially assigned to at least some of keys of the first and second key selection units 100 and 200. Although randomly assigned, the alphabets are preferably assigned to the 3-by-3 array of nine keys as shown in FIG. 8 so that the user can input characters conveniently and quickly.

The English alphabet array shown in FIG. 8 is set by considering the QWERTY array and the usage frequency of English alphabets. The QWERTYT array has a first group consisting of English alphabets inputted with a left hand, and a second group consisting of English alphabets inputted with a right hand.

That is, the first group consists of “q”, “w”, “e”, “r”, “t”, “a”, “s”, “d”, “f”, “g”, “z”, “x”, “c”, “v”, and “b” and the second group consists of “y”, “u”, “i”, “o”, “p”, “h”, “j”, “k”, “l”, “n”, and “m”. The first group is placed on the left or center of the 3-by-3 array, and the second group is placed on the right or center of the 3-by-3 array.

Furthermore, the English alphabets are divided into a first character set, a second character set, and a third character set according to the usage frequency, and a plurality of English alphabets assigned adjacent keys in the QWERTY array are assigned to the same key or adjacent keys.

For example, the first character set includes English alphabets consisting of “a”, “e”, “h”, “i”, “n”, “o”, “r”, “s”, and “t”, which have the highest usage frequency, the second character set includes English alphabets consisting of “c”, “d”, “f”, “g”, “l”, “m”, “p”, “u”,and “w”, and the third character set includes English alphabets consisting of “b”, “q”, “v”, “x”, “y”, and “z”.

The respective character sets may have usage frequencies different from actual usage frequencies to make an array similar to the QWERTY array. For example, even though “y” has a usage frequency a little higher than “p”, “y” belongs to the third character set and “p” belongs to the second character set.

The above-mentioned character array and input method are described in Korean Laid-Open Patent Application No. 2004-82326, and a detailed description thereof will be omitted herein.

Among the keys shown in FIG. 8, the Enter key, Tab key, Backspace key, and Space key are well known and a detailed description thereof will be omitted herein. The Separator ([sep]) key is used when consecutively inputting characters assigned to the same key, so that a current input character can be distinguished from the next input character. The [sep] key is also well known and a detailed description thereof will be omitted herein.

The [mode] key is used to change a character mode in the text mode. For example, when the [mode] key is input in a lowercase mode shown in FIG. 8, the key processing unit 300 changes a first character of each key of the first and second key selection units 100 and 200 to an upper case as shown in FIG. 9. This is called a sentence mode in which the first character is input as an upper case and the rest are input as lower cases. It is preferable that the character mode is changed to the lowercase mode after a first character is input as an upper case.

For example, when a sentence is initially input, the upper case “E”, “W” and “Q” are input when the [Ewq] key is pressed once, twice, and third times, respectively. Preferably, when a first upper case is input in a sentence mode, a changed alphabet may be automatically assigned in the first and second key selection units 100 and 200. For example, when the [Ewq] key is consecutively pushed before a predetermined time elapses to input an upper case as a first character in a sentence mode, English alphabets are automatically changed and assigned in the order of [eWq], [ewQ] and [Ewq].

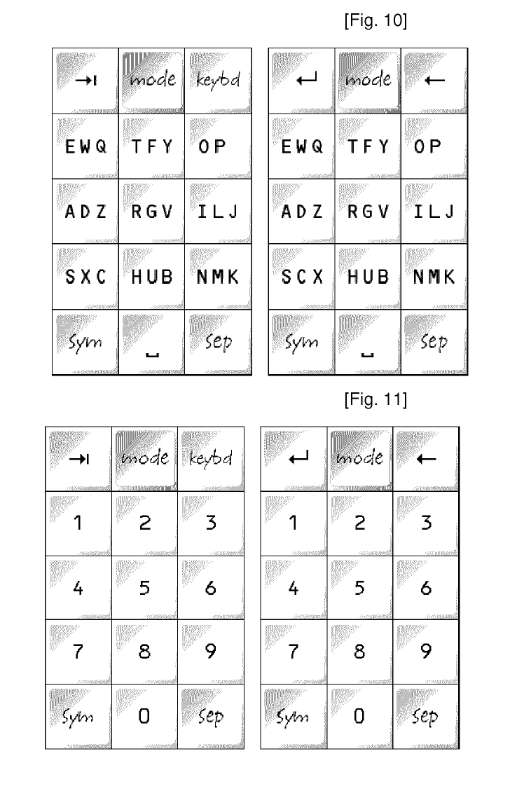

When the [mode] key is input in FIG. 9, the key processing unit 300 changes the character mode to an uppercase mode and assigns upper cases to the keys of the first and second key selection units 100 and 200 as shown in FIG. 10. When the [mode] key is input in FIG. 10, the key processing unit 300 changes the character mode to a numeral mode as shown in FIG. 11.

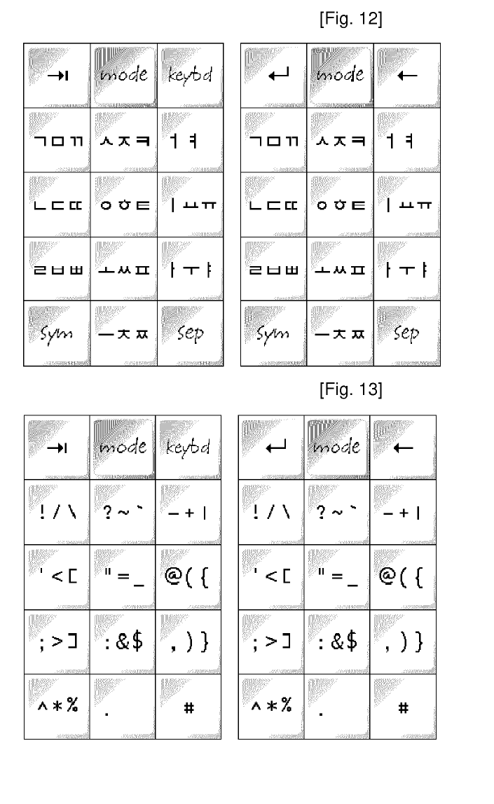

When the [mode] key is input in FIG. 11, the key processing unit 300 assigns an additional mode, such as Hanguel, the Korean alphabet, as shown in FIG. 12. When the [mode] key is input in FIG. 12, the key processing unit 300 changes back to the lowercase mode shown in FIG. 8.

FIG. 13 illustrates a symbol key mode in the text mode.

When the [sym] key is input in FIGS. 8 to 12, the key processing unit 300 assigns, for example, symbols to each key of the first and second key selection units 100 and 200 as shown in FIG. 13. That is, the [sym] key allows users to input symbols in any character mode in the text mode. For example, when a symbol is input in the symbol key mode shown in FIG. 13, the key processing unit 300 processes such that the symbol is output and then the mode is returned to the previous character mode.

The Hangeul keys shown in FIG. 12 are assigned considering the usage frequency, the relation with the continuous keyboard system etc. The symbol keys shown in FIG. 13 are preferably assigned considering similarity with numerals, usage frequency etc. The above-mentioned Hangeul array and symbol array shown in FIGS. 12 and 13 are described in the above-mentioned Korean Laid-Open Patent Application No. 2004-82326, and a detailed description thereof will be omitted herein.

A method for inputting keyboard characters will be described.

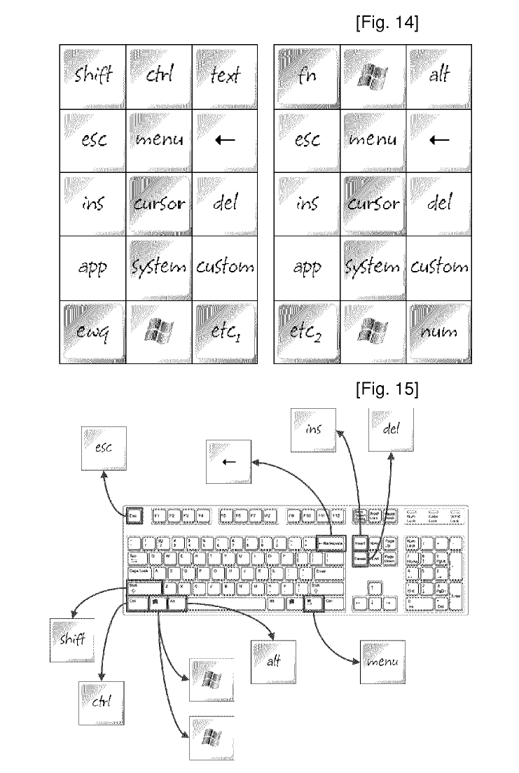

FIG. 14 illustrates keys assigned when a text mode is changed to a keyboard mode.

When the [keybd] key is input in the text mode shown in FIGS. 8 to 13, the key processing unit 300 changes the text mode to a keyboard mode and assigns keys of a computer keyboard to at lease some of keys of the first and second key selection units 100 and 200. As shown in FIG. 14, the first and second key selection units 100 and 200 include the Esc key, Ins key, Del key, Backspace key, Combination key etc. Examples of the Combination key include the Shift key, Ctrl key, Alt key, and Window key, which are used together with other keys and are toggled.

The key processing unit 300 processes the Esc key, Ins key, Del key, Backspace key, and Combination key in the same manner as the computer keyboard processes. The key processing unit 300 changes the color or shade of a character written on the combination key when the combination key is input, so that the toggling status can be identified.

FIG. 15 illustrates a computer keyboard related to FIG. 14.

The keys shown in FIG. 14 are ones which are marked with thick lines on the computer keyboard shown in FIG. 15.

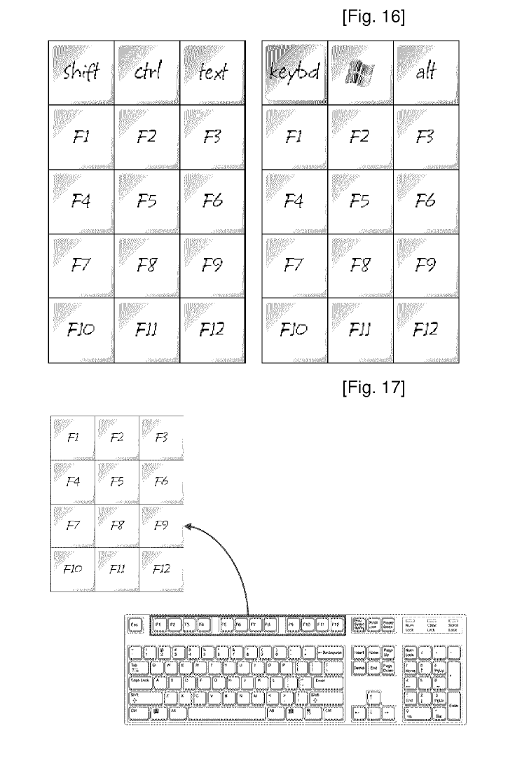

FIG. 16 illustrates assigned functions keys of the keyboard.

When the [fn] key is input in FIG. 14, the key processing unit 300 assigns F1 to F12 keys of the computer keyboard as shown in FIG. 9. The key processing unit 300 processes F1 to F12 keys which are input individually or in combination with the combination keys. For example, when F12 key is input on a MS-Word program, the key processing unit 300 loads a window named “Save as a different file name” like when F12 key is input on the computer keyboard.

FIG. 17 illustrates a computer keyboard related to FIG. 16.

The function keys shown in FIG. 16 are ones which are marked with thick lines on the computer keyboard shown in FIG. 17.

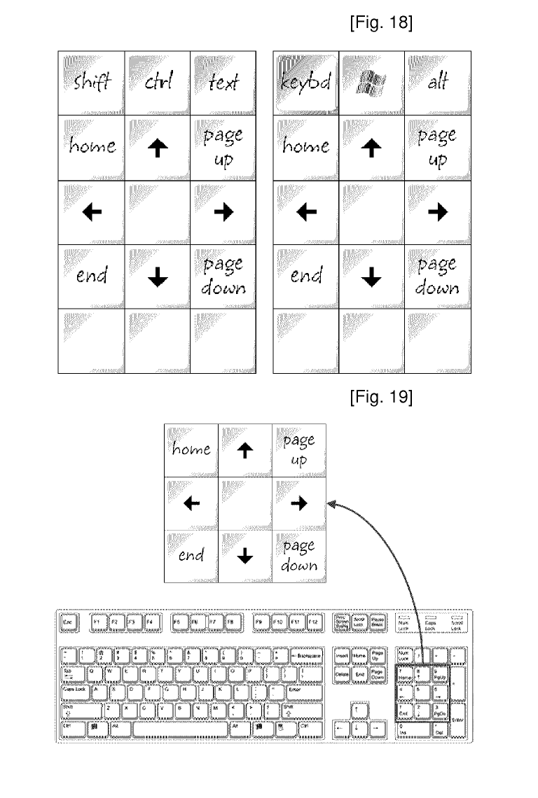

FIG. 18 illustrates assigned movement keys of the keyboard.

When the [cursor] key shown in FIG. 14 is input, the key processing unit 300 assigns cursor movement keys on the computer keyboard, such as “←” key, “→” key, “↑” key, “↓” key, Home key, End key, Page-up key, and Page-down key as shown in FIG. 14. The key processing unit 300 processes the input [cursor] key like when the movement keys are input on the keyboard.

FIG. 19 illustrates a computer keyboard related to FIG. 18.

The movement keys shown in FIG. 18 are ones which are marked with thick lines on the keyboard shown in FIG. 19.

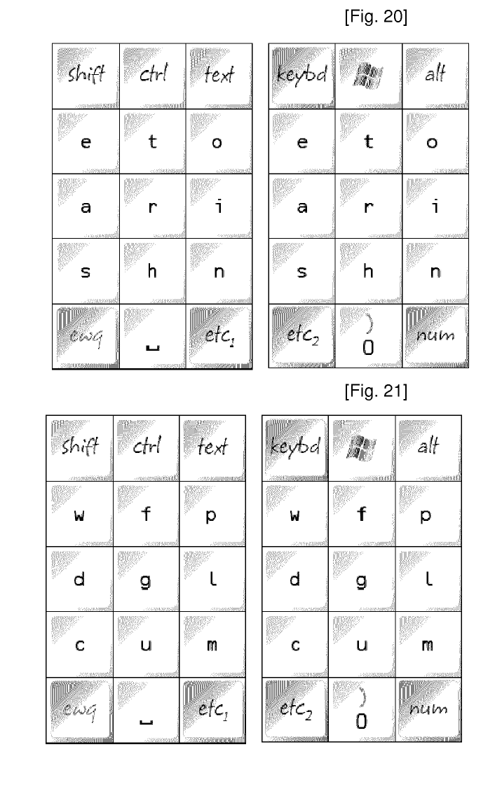

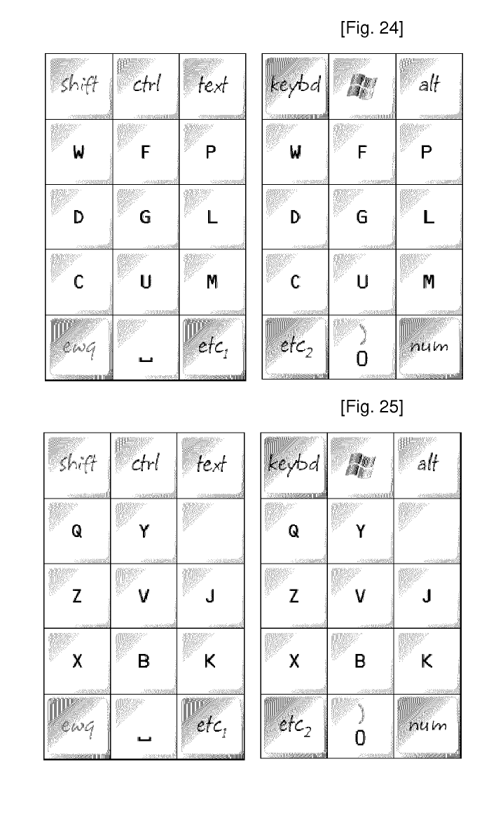

FIGS. 20 to 25 illustrate assignment of alphabet input keys of the keyboard.

When the [ewq] key shown in FIG. 14 is input, the key processing unit 300 assigns some of the English alphabets of the computer keyboard. For example, when the [ewq] key shown in FIG. 14 is input, alphabets belonging to a first character set, a second character set, or a third character set are assigned one-to-one to the keys by the key processing unit 300. When the [ewq] key is input again, alphabets belonging to a character set other than the current character set are assigned one-to-one to the keys by the key processing unit 300.

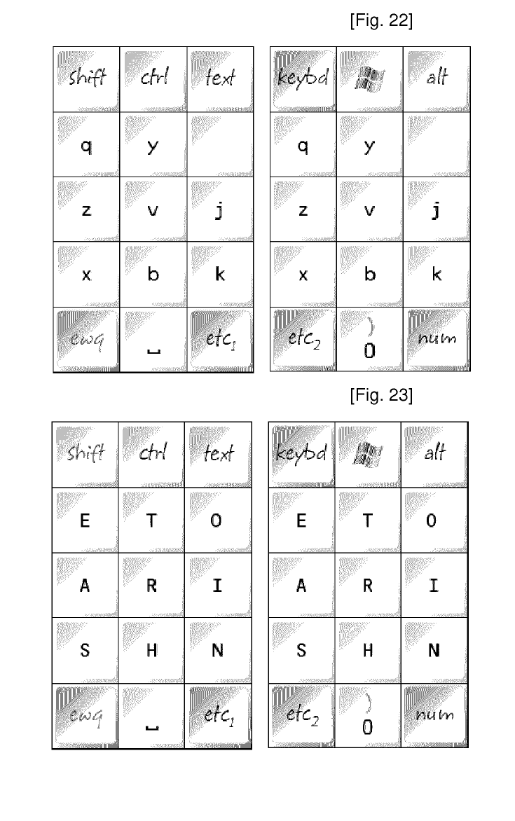

Preferably, whenever the [ewq] key is input, alphabets belonging to a first character set, a second character set, and a third character set are sequentially assigned one-to-one to the keys in this order by the key processing unit 300. That is, when the [ewq] key is first input, alphabets belonging to the first character set are assigned one-to-one to the keys by the key processing unit 300 as shown in FIG. 20. When the [ewq] key is input again in FIG. 20, alphabets belonging to the second character set are assigned one-to-one to the keys as shown in FIG. 21. In addition, when the [ewq] key is input again in FIG. 21, alphabets belonging to the third character set are assigned one-to-one to the keys as shown in FIG. 22.

As described above, the first, second and third character sets are preferably divided based on the usage frequency of English alphabets. Therefore, the alphabets belonging to the first character set are “a”, “e” , “h”, “i”, “n”, “o”, “r”, “s”, and “t”, which have the highest usage frequency. The alphabets belonging to the second character set are “c”, “d”, “f”, “g”, “l”, “m”, “p”, “u”, and “w”. The alphabets belonging to the third character set are “b”, “j”, “k”, “q”, “v”, “x”, “y”, and “z”. They are preferably arranged in the alphabet array shown in FIG. 8.

When the [shift] key is input in FIGS. 20 to 22, the key processing unit 300 toggles the [shift] key and changes the lower case to the upper case as shown in FIGS. 23 to 25. This is similar to a case where the Shift key and an English alphabet key are pushed together on the keyboard, or where an English alphabet key is pushed with the CapsLock key turned on. That is, when an English alphabet key is pushed with the [shift] key activated, an upper case is displayed on the display.

Accordingly, the user can input uppercase alphabets on the key array of the key selection units 100 and 200 shown in FIGS. 23 to 25, and the key processing unit 300 processes and displays the input alphabets on the display.

In addition to the [shift] key, the English alphabets can be input in combination with the other combination keys, such as [ctrl], [alt] and [windows] keys. For example, when the [windows] key is activated and the alphabet “e” is input, the key processing unit 300 loads the “Explorer window” like when the windows key and the alphabet “e” key are pushed on the computer keyboard.

For another example, when the [ewq] key shown in FIG. 14 is input, the key processing unit 300 assigns the English alphabet array shown in FIG. 8 so that one of the alphabets assigned to the keys can be input. For instance, when a computer is used with a mouse having three buttons, a first alphabet of each key is input by clicking the left of the mouse, a second alphabet is input by clicking the middle of the mouse, and a third by the right of the mouse.

More preferably, when the [ewq] key shown in FIG. 14 is input, the key processing unit 300 assigns alphabets to a 3-by-3 array of nine keys among the limited number of keys of the key selection units 100 and 200. In this case, the alphabets on the computer keyboard are divided into a first group consisting of alphabets, which are input with a left hand, and a second group consisting of alphabets, which are input with a right hand. The alphabets belonging to the first group are arranged on the left or center columns of the 3-by-3 array, and the alphabets belonging to the second group are arranged on the right or center columns. The alphabets belonging to the first, second and third character sets, which are divided based on the usage frequency of the alphabets, are assigned one by one.

The array of alphabets thus arranged is the same as that of FIG. 8. This allows the characters to be efficiently input.

When the alphabets are assigned in the keyboard mode as shown in FIG. 8, lower cases or upper cases may be input as shown in FIG. 8 or 10 by toggling the [shift] key.

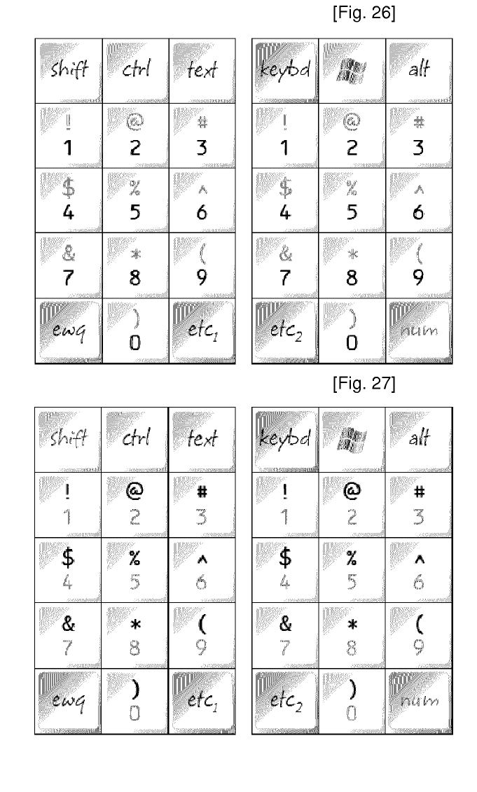

FIGS. 26 to 27 illustrate assignment of numeral and symbol keys of a keyboard.

When the numeral keys shown in FIGS. 14, 16, 18, and 20 to 25 are input, the key processing unit 300 assigns keys having both numeral and symbol as shown in FIG. 26. The symbol can be input when the [shift] key is activated. Therefore, when the [shift] key is not activated, the numerals “0” to “9”0 are marked thickly as shown in FIG. 26 to indicate that the numerals can be input. When the [shift] key is activated, the symbols are marked thickly as shown in FIG. 27 to indicate that the symbols can be input.

Accordingly, the user can input the numerals and symbols with the same keys as those of the keyboard, and the key processing unit 300 processes and outputs the input numeral or symbol on the display.

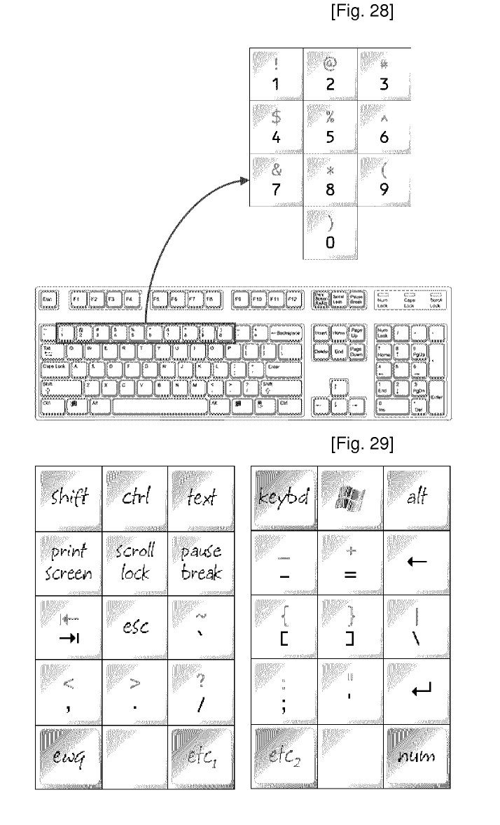

FIG. 28 illustrates a computer keyboard related to FIG. 26.

The numeral and symbol keys of the computer keyboard shown in FIG. 26 are ones which are marked with thick lines on the keyboard shown in FIG. 28.

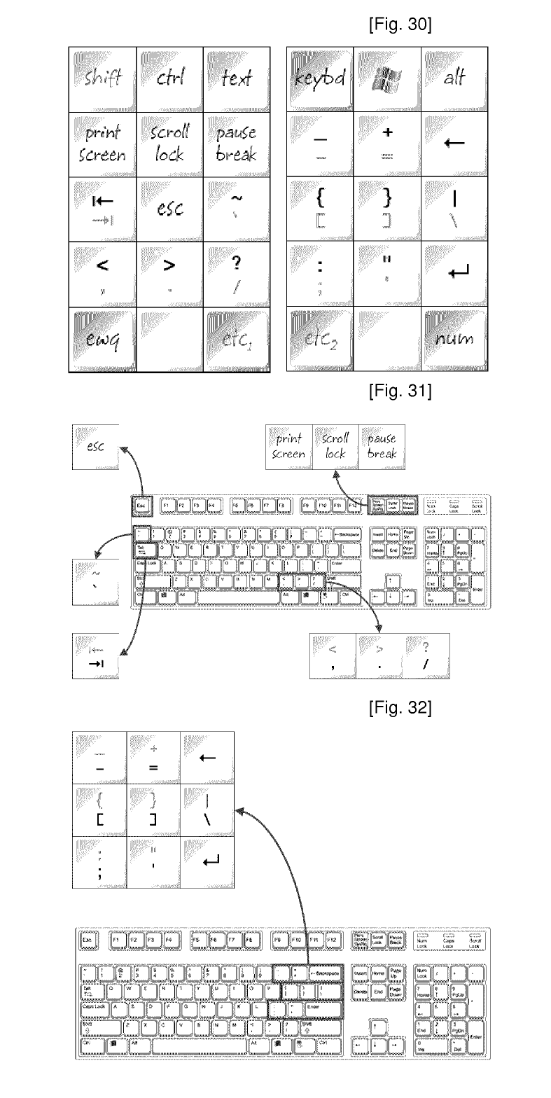

FIGS. 29 and 30 illustrate assignment of remainder keys of the computer keyboard. When the [etc₁] or [etc₂] key is input in FIGS. 14, 20 to 25, 26, and 27, the key processing unit 300 assigns the symbol and remainder keys of the computer keyboard as shown in FIG. 29. Different symbol and remainder keys are preferably assigned to at least some of keys of the key selection units 100 and 200. However, the same symbol and remainder keys may be assigned.

The keys having two symbols in FIG. 29 are activated by toggling the [shift] key so that one of them can be input. That is, the key processing unit 300 activates lower symbols as shown in FIG. 29 when the [shift] key is not activated, while the key processing unit 300 activates upper symbols as shown in FIG. 30 when the [shift] key is activated.

Accordingly, the user can input assigned symbol keys as well as the [print screen] key, [scroll lock] key, [pause break] key, [tab] key, and [esc] key through the key array shown in FIGS. 29 and 30. In addition to the [shift] key, the other combination keys, such as [ctrl] key, [alt] key and [windows] key, can be activated to input keys.

FIG. 31 illustrates a computer keyboard related to the first key selection unit of FIG. 29. FIG. 32 illustrates a computer keyboard related to the second key selection unit of FIG. 29.

The remainder keys on the computer keyboard shown in FIG. 29 are ones which are marked with thick lines on the keyboard shown in FIGS. 31 and 32.

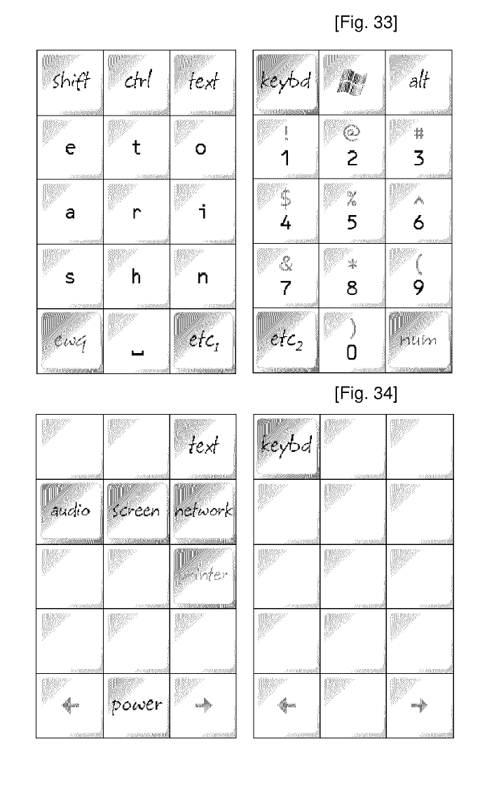

FIG. 33 illustrates assignment of character keys, and numeral and symbol keys of the computer keyboard.

When the [ewq] or [num] key shown in FIG. 14 is input, the key processing unit 300 assigns some of the alphabet keys of the keyboard to at least some of the keys of the first key selection unit 100, and assigns the numeral and symbol keys of the keyboard to at least some of the keys of the second key selection unit 200 as shown in FIG. 33. That is, the alphabets can be input through the first key selection unit 100 while the numerals and symbols can be input through the second key selection unit 200. In this case, the alphabets may be assigned to the first key selection unit 100 as shown in FIG. 8. The [ewq] key or the combination key may be input in FIG. 33 to assign other alphabets.

The combination key preferably remains assigned in the keyboard mode so that it can be always used with other keys.

A method for supporting supplemental functions will be described.

FIGS. 34 to 38 illustrate assigned system keys.

When the [system] key shown in FIG. 14 is input, the key processing unit 300 assigns high-level system-related keys to the first key selection unit 100 as shown in FIG. 34. The second key selection unit 200 is left vacant to assign low-level system-related keys which correspond to keys selected from among the high-level system-related keys. Examples of the high-level system-related keys include audio key, screen key, network key and power key.

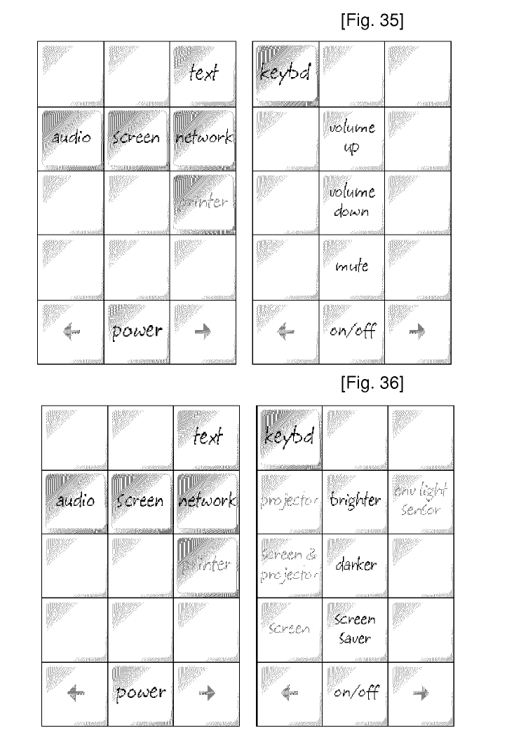

FIG. 35 illustrates assigned audio-related keys.

When the [audio] key assigned to the first key selection unit 100 is input, the key processing unit 300 assigns audio-related keys, such as volume-control key and power key, to the second key selection unit 200 as shown in FIG. 20.

FIG. 36 illustrates assigned screen-related keys.

When the [screen] key assigned to the first key selection unit 100 is input, the key processing unit 300 assigns screen-related keys, such as brightness-control key, projector-connection key, screensaver key, and power key, to the second key selection unit 200 as shown in FIG. 36.

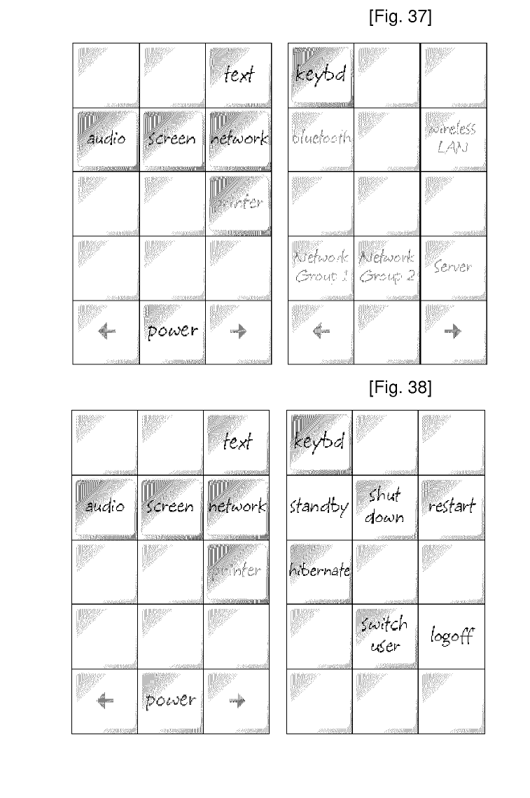

FIG. 37 illustrates assigned network-related keys.

When the [network] key assigned to the first key selection unit 100 is input, the key processing unit 300 assigns network-related keys, such as Bluetooth, wireless LAN, and network groups, to the second key selection unit 200 as shown in FIG. 37.

FIG. 38 illustrates assigned power-related keys.

When the [power] key assigned to the first key selection unit 100 is input, the key processing unit 300 assigns power-related keys, such as restart, logoff, shutdown, standby etc., to the second key selection unit 200 as shown in FIG. 38.

The key processing unit 300 processes keys assigned to the second key selection unit 200 shown in FIGS. 35 to 38.

The above-mentioned system-related keys are preferably activated or deactivated according a given condition.

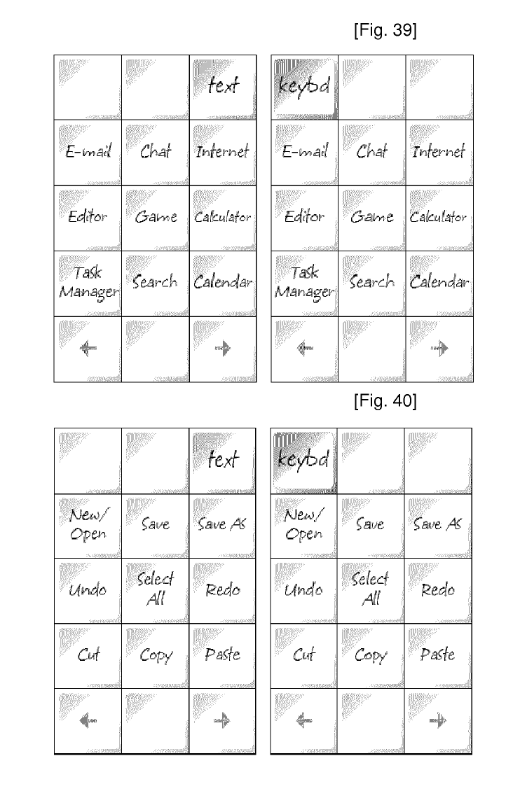

FIG. 39 illustrates assigned user-defined application keys.

When the [app] key is input in FIG. 14, the key processing unit 300 assigns user-defined application keys as shown in FIG. 39, and executes an application when a key is input.

FIG. 40 illustrates assigned user-defined keys.

When the [custom] key is input in FIG. 14, the key processing unit 300 assigns user-defined keys, such as macro and batch job, as shown in FIG. 40.

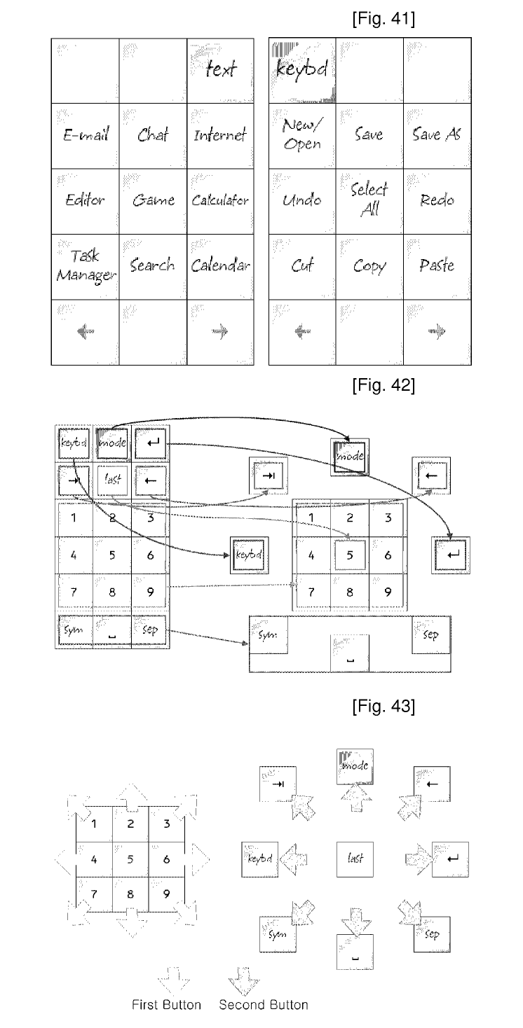

When the [app] or [custom] key is input in FIG. 14, the key processing unit 300 assigns application keys to the first key selection unit 100, and assigns user-defined keys to the second key selection unit 200 as shown in FIG. 41.

When the [keybd] key is input in FIGS. 16, 18, 20 to 25, 26, 27, 29, 30, 33, 34 to 38, 39, 40, and 41, the key processing unit 300 returns key assignment of the key selection units 100 and 200 to the default key array in the keyboard mode shown in FIG. 14.

When the [text] key is input in FIGS. 14, 16, 18, 20 to 25, 26, 27, 29, 30, 33, 34 to 38, 39, 40 and 41, the key processing unit 300 switches from the keyboard mode to the text mode. In this case, the key processing unit 300 switches to a key array of a character mode prior to switching to the keyboard mode, or to the default key array in FIGS. 8 to 13. The default key array may be one shown in FIG. 8.

The key selection units 100 and 200 may have keys with different colors to distinguish the keys from one another. For example, blue keys indicate that some of the keys of the key selection units 100 and 200 are reassigned to other keys, red keys indicate combination keys, and green keys indicate keys which are actually input.

FIG. 42 illustrates a key array for a joystick according to an exemplary embodiment of the invention.

The key selection unit has a 3-by-3 array of keys in its center, and eight keys, which are provided around the 3-by-3 array.

FIG. 43 illustrates an input method in a joystick.

A first button of the joystick may be pushed to input 3-by-3 keys, and its second button may be pushed to input the other keys. The first and second buttons may be operated to select the numeral 5 or the [last] key without moving the joystick, and to select the other keys after the joystick is moved in corresponding directions

The above-mentioned method according to the present embodiment of the invention may be stored in any form of recording media, such as CD-ROM, RAM, ROM, floppy disk, hard disk, or magneto-optical disk, or in any computer-readable form, such as computer code organized into executable programs. A description of a method of storing an exemplary embodiment of the present invention is well known in the art and will be omitted.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention can be efficiently applied to a method and apparatus for conveniently inputting characters with both hands, and for inputting characters as many as possible with a limited number of keys.

1. A dual input apparatus comprising:
a first key selection unit having a limited number of keys for a left hand;
a second key selection unit having the same number of keys for a right hand as the first key selection unit; and
a key processing unit to analyze and process a key selected by the first or second key selection unit.

2. The dual input apparatus of claim 1,
wherein the key processing unit assigns characters in a text mode to at least some of the limited number of keys of the first and second key selection units and outputs a selected key; and assigns keys of a computer keyboard in a keyboard mode to at least some of the limited number of keys of the first and second key selection units and processes an action corresponding to the selected key.

3. The dual input apparatus of claim 2, wherein the key processing unit reassigns other keys of the computer keyboard to at least some of the limited number of keys when the key selected by the first of second key selection unit is input in the keyboard mode.

4. The dual input apparatus of claim 3, wherein the key processing unit assigns combination keys of the computer keyboard in the keyboard mode to at least some of the limited number of keys of the first and second key selection units, the first and second key selection units having the same key array.

5. The dual input apparatus of claim 4, wherein the combination keys comprise at least some of Shift key, Ctrl key, Alt key, and Windows key.

6. The dual input apparatus of claim 5, wherein the combination keys remain assigned in the keyboard mode.

7. The dual input apparatus of claim 4, wherein the combination keys are toggled when selected.

8. The dual input apparatus of claim 3, wherein the key processing unit assigns function keys F1 to F12 of the computer keyboard to 15 keys of the limited number of keys in each of the first and second key selection units when a function key selected by the first or second key selection unit is input in the keyboard mode.

9. The dual input apparatus of claim 3, wherein the key processing unit assigns movement keys of the computer keyboard to some of the limited number of keys in each of the first and second key selection units when a cursor key selected by the key selection unit is input in the keyboard mode.

10. The dual input apparatus of claim 9, wherein the movement keys comprise at least some of “←” key, “→” key, “↑” key, “↓” key, Home key, End key, Page-Up key, and Page-Down key.

11. The dual input apparatus of claim 3, wherein the key processing unit makes a one-to-one assignment of alphabets belonging to a first character set, a second character set, or a third character set to some of the limited number of keys in each of the first and second key selection units when a character assignment key selected by the first or second key selection unit is input in the keyboard mode.

12. The dual input apparatus of claim 11, wherein the key processing unit reassigns another character set when the character assignment key is input again in the keyboard mode.

13. The dual input apparatus of claim 3, wherein the key processing unit makes a one-to-one assignment of alphabets belonging to a first character set, a second character set, and a third character set to some of the limited number of keys in each of the first and second key selection units when a character assignment key selected by the first or second key selection unit is input in the keyboard mode.

14. The dual input apparatus of claim 3,
wherein the key processing unit assigns alphabets of the computer keyboard to a 3-by-3 array of nine keys among the limited number of keys in each of the first and second key selection units when a character assignment key selected by the first or second key selection unit is input in the keyboard mode,
wherein the alphabets are divided into a first group consisting of alphabets, which are input with a left hand, and a second group consisting of alphabets, which are input with a right hand, the alphabets belonging to the first group being arranged on the left or center columns of the 3-by-3 array, and the alphabets belonging to the second group being arranged on the right or center columns, and
wherein alphabets belonging to a first character set, a second character set, and a third character set, which are divided based on the usage frequency of the alphabets, are assigned one by one.

15. The dual input apparatus of claim 11, wherein the key processing unit assigns lower cases or upper cases of the alphabets when the Shift key is toggled in the keyboard mode.

16. The dual input apparatus of claim 3, wherein the key processing unit assigns keys having the numeral/symbol of the computer keyboard to some of the limited number of keys in each of the first and/or second key selection units when a numeral assignment key selected by the first or second key selection unit is input in the keyboard mode.

17. The dual input apparatus of claim 16, wherein the key processing unit activates the keys having numeral/symbol so that the numeral/symbol can be alternately input when the Shift key is toggled.

18. The dual input apparatus of claim 16, wherein the key processing unit assigns keys having two symbols and/or the remainder keys of the computer keyboard to some of the limited number of keys in each of the first and/or second key selection units when a key selected by the first or second key selection unit is input in the keyboard mode.

19. The dual input apparatus of claim 18, wherein the key processing unit activates the keys having two symbols so that the two symbols can be alternately input when the Shift key is toggled.

20. The dual input apparatus of claim 18, wherein the remainder key comprises at least some of Esc key, Tab key, Enter key, Print-screen key, Scroll-lock key, and Pause-break key.

21. The dual input apparatus of claim 2, wherein the key processing unit assigns power-related keys to some of the limited number of keys in each of the first and/or second key selection units when a power key selected by the first or second key selection unit is input in the keyboard mode.

22. The dual input apparatus of claim 21, wherein the power-related keys comprise at least some of Reboot key, Log-off key, User-switch key, Shut-down key, Standby key, and Hibernate key.

23. The dual input apparatus of claim 3, wherein the key processing unit assigns application keys to some of the limited number of keys in each of the first and/or second key selection units when an application key selected by the first or second key selection unit is input in the keyboard mode.

24. The dual input apparatus of claim 3, wherein the key processing unit switches between the keyboard mode and the text mode when a mode-switch key selected by the first or second key selection unit is input.

25. The dual input apparatus of claim 3,
wherein the key processing unit assigns alphabets of the computer keyboard in the text mode to a 3-by-3 array of nine keys among the limited number of keys in each of the first and second key selection units,
wherein the alphabets are divided into a first group consisting of alphabets, which are input with a left hand, and a second group consisting of alphabets, which are input with a right hand, the alphabets belonging to the first group being arranged on the left or center columns of the 3-by-3 array, and the alphabets belonging to the second group being arranged on the right or center columns, and
wherein alphabets belonging to a first character set, a second character set, and a third character set, which are divided based on the usage frequency of the alphabets, are assigned one by one, alphabets assigned to adjacent keys of the computer keyboard being assigned to a single key or adjacent keys.

26. The dual input apparatus of claim 3, wherein the key processing unit sequentially assigns alphabet mode, numeral mode, and symbol mode to the key selection unit when a predetermined key is input in the text mode through the first or second key selection unit.

27. The dual input apparatus of claim 3, wherein the key processing unit sequentially assigns alphabet mode, language mode, numeral mode, and symbol mode to the key selection unit when a predetermined key is input in the text mode through the first or second key selection unit.

28. A method for inputting characters provided on a computer keyboard, comprising:
assigning characters in a text mode to at least some of a limited number of keys in each of first and second key selection units for left and right hands, respectively, and outputting a character of a selected key, the first and second key selection units having the same number of keys; and
assigning keys of the computer keyboard in a keyboard mode to at least some of the limited number of keys in each of the first and second key selection units, and processing an action corresponding to the selected key.

29. The method of claim 28, wherein assigning keys of the computer keyboard comprises reassigning other keys of the computer keyboard to at least some of the limited number of keys in each of the first and second key selection units when a key selected by the first or second key selection unit is input in the keyboard mode.

30. A computer readable medium having a program to execute on a computer the method of claim 28.
